(19) United States
(12) Patent Application Publication
(10) Pub. No.: US 2026/0151893 A1
(43) Pub. Date: Jun. 4, 2026

(54) TELESCOPIC SHOTGUN STICK, LOCKING DEVICE, AND COMBINATION THEREOF

(71) Applicant: Utility Solutions, Inc., Hickory, NC (US)

(72) Inventors: Peter Lawrence Shirilla, Hickory, NC (US); Thomas Scott Beane, Hudson, NC (US); Eugene H. Wood, Hickory, NC (US)

(21) Appl. No.: 19/386,354

(22) Filed: Nov. 12, 2025

Related U.S. Application Data
(60) Provisional application No. 63/726,775, filed on Dec. 2, 2024.

(51) Int. Cl. B25J 1/04; B25G 1/04; B25G 1/12; F16B 7/14; H02G 1/04

(52) U.S. Cl. CPC B25J 1/04; B25G 1/04; F16B 7/14; H02G 1/04; B25G 1/12

(57) ABSTRACT

A telescoping shotgun stick is disclosed. The shotgun stick includes a hotstick assembly including an outer tube and an inner tube configured to slide within the outer tube; a telescoping rod assembly including: an outer rod tube; an inner rod configured to slide within the outer rod tube; and a locking mechanism secured to a second end of the outer rod tube, the locking mechanism having a housing with a bore therethrough and first and second actuators extending into the bore; a hook connected to an end of the inner rod; and a hook operating assembly connected to a first end of the outer rod tube, wherein movement of the hook operating assembly causes the hook to move from an open position to a closed position.

### BACKGROUND OF THE INVENTION

This invention relates generally to electrical utility tools, and more particularly to a shotgun stick and locking device.

Utility workers frequently carry out installation, maintenance, or repair on electrical transmission or distribution lines (conductors) mounted above ground level (i.e., “overhead wires”). One of the tools used by utility workers is a shotgun stick or hot stick to allow utility workers to reach, remove, and install components safely.

One of the issues when using a telescoping shotgun stick is the disengagement of the operating rod mechanism, i.e., accidental shortening or lengthening of the shotgun stick or difficulty in operating the operating rod mechanism to extend or shorten the shotgun stick.

Accordingly, there is a need for a shotgun stick with a rod mechanism that is easy to use and prevents accidental shortening or lengthening of the shotgun stick.

### BRIEF SUMMARY OF THE INVENTION

This problem is addressed by a spring-loaded, opposing button operating rod mechanism that prevents accidental shortening or lengthening and at the same time is intuitive and easy to use.

According to one aspect, a telescoping shotgun stick includes a hotstick assembly including an outer tube and an inner tube configured to slide within the outer tube; a telescoping rod assembly including: an outer rod tube; an inner rod configured to slide within the outer rod tube; and a locking mechanism secured to a second end of the outer rod tube, the locking mechanism having a housing with a bore therethrough and first and second actuators extending into the bore, wherein when in an unactuated position, the first and second actuators prevent the inner rod from sliding in the outer tube and when in an actuated position, the first and second actuators allow the inner rod to slide in the outer tube; a hook connected to an end of the inner rod; and a hook operating assembly connected to a first end of the outer rod tube, wherein movement of the hook operating assembly causes the hook to move from an open position to a closed position.

According to another aspect, the first actuator is positioned on a first side of the housing and the second actuator is positioned on an opposing second side of the housing.

According to another aspect, each of the first and second actuators include a body having a first actuating end, a second engagement end spaced from the first actuating end, and an aperture extending through the body between the first actuating end and second engagement end to permit the inner rod to slide through the aperture.

According to another aspect, the second engagement end includes a slot engagement member for engaging a slot of the inner rod, the slot engagement member at least partially interfering with the aperture.

According to another aspect, the inner rod includes first and second rod sections connected together by a rod connector in an end to end configuration.

According to another aspect, the rod connector includes a slot for engagement by the first and second actuators to prevent the inner rod from sliding in the outer rod tube.

According to another aspect, the inner tube is locked in position relative to the outer tube by an actuator extending through an aperture in the outer tube.

According to another aspect, the hook operating assembly includes a housing, a gear rack connected to the outer tube, and a pawl pivotally connected to the housing for engagement with the gear rack.

According to another aspect, the housing is connected to the first end of the outer rod tube.

According to another aspect, the hook operating assembly further includes an actuator disposed in the housing adapted to permit the hook operating assembly to move to a first operating position where the hook is fully opened.

According to another aspect, a locking mechanism for a telescoping rod assembly having an outer rod tube and an inner rod includes a housing having a bore therethrough, the housing being connected to an end of the outer rod tube; a first actuator disposed on a first side of the housing and a second actuator disposed on a second side of the housing, wherein each of the first and second actuators include an aperture extending therethrough for receiving the inner rod therein; wherein in an unactuated position, at least a portion of each of the first and second actuators interfere with the bore to prevent the inner rod from sliding through the bore, and in an actuated position, the first and second actuators do not interfere with the bore, thereby allowing the inner rod to slide through the bore.

According to another aspect, further including a first spring adapted to bias the first actuator in the unactuated position to prevent the inner rod from sliding and a second spring adapted to bias the second actuator in the unactuated position to prevent the inner rod from sliding.

According to another aspect, each of the first and second actuators include a body; a first actuating end extending out of the housing for actuation by a user; a second engagement end spaced from the first actuating end for engagement with the inner rod; and an aperture extending through the body between the first actuating end and the second engagement end to permit the inner rod to slide through the aperture.

According to another aspect, the second engagement end includes a slot engagement member for engaging a slot of the inner rod, the slot engagement member at least partially interfering with the aperture.

According to another aspect, in the actuated position, the aperture of the first and second actuators is aligned with the bore of the housing to permit the inner rod to slide through both the aperture and the bore, and wherein in the unactuated position, the aperture of the first and second actuators is not aligned with the bore such that the second engagement end of the first and second actuators interfere with the bore and prevent the inner rod from sliding in the aperture and the bore.

According to another aspect, a method of operating the telescoping shotgun stick of claim 1 includes moving the hook operating assembly to a first position to open the hook; receiving a cable in the hook and moving the hook operating assembly to a second position where the hook is closed to capture the cable; and moving the hook operating assembly to a third position where the cable is compressed between the hook and a housing connected to a second end of the hotstick assembly.

According to another aspect, further including the steps of: disengaging the inner tube of the hotstick assembly from the outer tube; actuating the first and second actuators of the locking mechanism to disengage the locking mechanism from the inner rod; and extending or retracting the telescoping shotgun stick to a desired length.

According to another aspect, the step of moving the hook operating assembly to the first position includes the steps of actuating an actuator and pawl of the of the hook operating assembly at the same time and pushing the hook operating assembly forward towards the second end of the hotstick assembly.

According to another aspect, the step of moving the hook operating assembly to the second position includes the step of pulling the hook operating assembly from the first position towards a first end of the hotstick assembly into the second position.

According to another aspect, the step of moving the hook operating assembly to the third position includes the step of pulling the hook operating assembly from the second position towards a first end of the hotstick assembly into the third position.

### BRIEF DESCRIPTION OF THE DRAWINGS

The invention may be best understood by reference to the following description taken in conjunction with the accompanying drawing figures, in which:

FIG. 1 is a side view of an exemplary shotgun stick, in a first length, with a hook operating assembly in a first operating position;

FIG. 2 shows a button operated rod mechanism connected to a hook of the shotgun stick of FIG. 1;

FIG. 3 shows the hook operating assembly of FIG. 1;

FIG. 4 is a side view of the shotgun stick of FIG. 1 with the hook operating assembly in a second operating position;

FIG. 5 is a side view of the shotgun stick of FIG. 1, in a second length, with the hook operating assembly in the second operating position;

FIG. 6 is a side view of the shotgun stick of FIG. 5 with the hook operating assembly in a third operating position;

FIG. 7 is a side view of the shotgun stick of FIG. 1, in a third length, with the hook operating assembly in the second operating position;

FIG. 8 is a perspective view of the locking mechanism of FIG. 2;

FIG. 9 is an end view of the locking mechanism of FIG. 8, in a locked position;

FIG. 10 is a cross-sectional view of the locking mechanism of FIG. 9;

FIG. 11 is an end view of the locking mechanism of FIG. 2, in an unlocked position;

FIG. 12 a cross-sectional view of the locking mechanism of FIG. 11;

FIG. 13 is a perspective view of an actuator of the locking mechanism of FIG. 8;

FIG. 14 shows the locking mechanism of FIG. 2 engaged with internal and external rods;

FIG. 15 is a cross-sectional view of FIG. 14;

FIG. 16 shows the locking mechanism of FIG. 2 disengaged with internal and external rods;

FIG. 17 is a cross-sectional view of FIG. 16;

FIG. 18 shows the locking mechanism of FIG. 16 with the internal rod sliding outwardly from the external rod once disengaged from the locking mechanism; and

FIG. 19 is a cross-sectional view of FIG. 18.

### DETAILED DESCRIPTION OF THE INVENTION

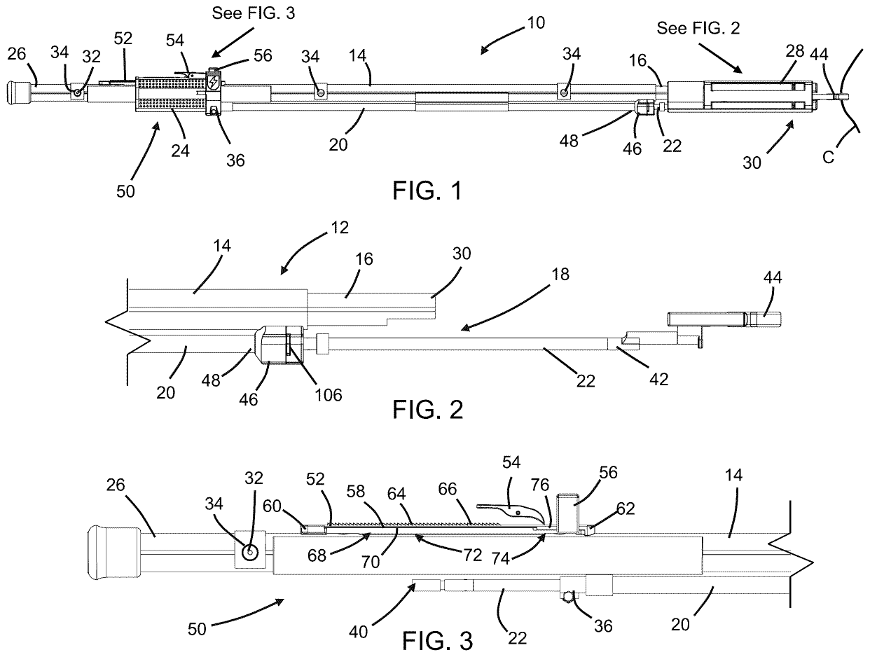

Referring to the drawings wherein identical reference numerals denote the same elements throughout the various views, FIGS. 1-7 illustrate an exemplary shotgun stick 10. The shotgun stick 10 is preferably made of an insulating material such as fiberglass and includes a telescoping hotstick assembly 12 having an outer tube 14 and an inner tube 16 configured to slide within the outer tube 14, a telescoping rod assembly 18 having an outer rod tube 20 and an inner rod 22 configured to slide within the outer rod tube 20, a first housing 24 disposed proximate a first end 26 of the shotgun stick 10 and a second housing 28 disposed on a second end 30 of the shotgun stick 10.

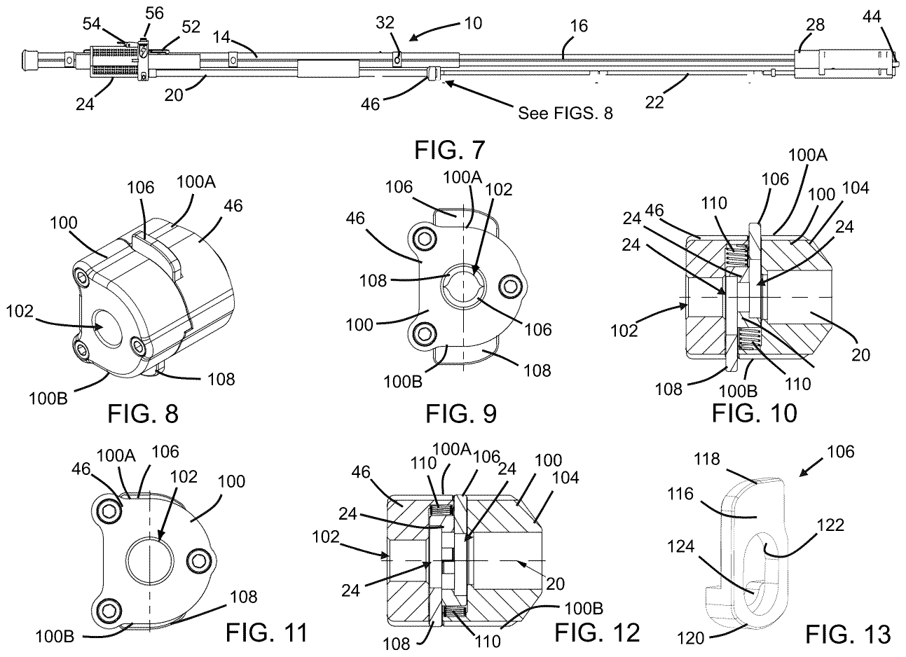

The inner tube 16 of the hotstick assembly 12 is locked in position using a spring-loaded actuator 32 extending through an aperture 34 disposed in the outer tube 14. As illustrated, the outer tube 14 of shotgun stick 10 includes three apertures 34 to provide the shotgun stick 10 with three lengths “L”. It should be appreciated that additional apertures 34 may be used in the outer tube 14 to provide additional lengths. The actuator 32 is connected to the inner tube 16 and snaps through an aperture 34 to engage the aperture 34 when the actuator 32 is aligned with the aperture 34 to lock the outer tube 14 and inner tube 16 of the hotstick assembly 12 together at a desired length. As illustrated, FIG. 1 shows the hotstick assembly 12 locked in a first length, FIG. 5 shows the hotstick assembly 12 locked in a second length, and FIG. 7 shows the hotstick assembly 12 locked in a third length. The actuator 32 is disengaged from the aperture 34 by depressing the actuator 32 until the actuator disengages the aperture 34 and allows the inner tube 16 to slide within the outer tube 14.

The telescoping rod assembly 18 is configured to extend and retract with the hotstick assembly 12. A first end 36 of the outer rod tube 20 is connected to the first housing 24. The outer rod tube 20 moves with the first housing 24 (discussed in more detail below). The inner rod 22 is configured to slide within the outer rod tube 20 with a first end 40 of the inner rod 22 contained within the outer rod tube 20 and a second end 42 of the inner rod 22 extending outwardly from the outer rod tube 20 into the second housing 28 and connected to a hook 44 housed in the second housing 28, see FIG. 2. The inner rod 22 is locked in position by a locking mechanism 46 connected to a second end 48 of the outer rod tube 20.

The hook 44 is operated using a hook operating assembly 50. The hook operating assembly 50 includes the first housing 24, a gear rack 52 connected to the outer tube 14, a pawl 54 pivotally connected to the first housing 24 for operation with the gear rack 52, and an actuator 56 disposed in the first housing 24 for operation with the gear rack 52. As shown in FIG. 3, the gear rack 52 includes a platform 58 disposed between first and second legs 60, 62. The platform 58 includes a plurality of teeth 64 disposed along a top surface 66 of the platform 58. The first and second legs 60, 62 elevate the platform 58 to form a groove 68 between a bottom surface 70 of the platform 58 and the outer tube 14. As illustrated, the platform 58 has a first thickness to form a first groove portion 72 and a second thickness to form a second groove portion 74, the second thickness being greater than the first thickness. The second thickness of the platform 58 creates a wall 76 extending into the first groove portion 72 to define the second groove portion 74.

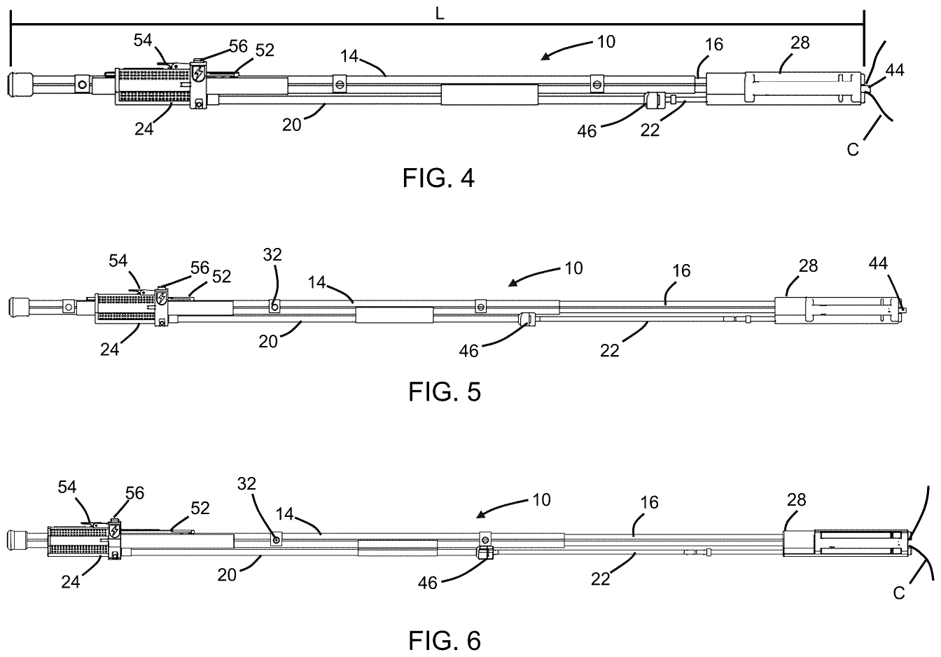

In operation, when a user wants to open the hook 44 and engage a cable “C” or other utility item, the user moves the hook operating assembly 50 to a first operating position by pressing the actuator 56 and the pawl 54 to disengage the pawl 54 from the gear rack 52 and to move the actuator 56 to a position in the first groove portion below the wall 76. The hook operating assembly 50 is then moved forward by sliding the first housing 24 forward toward the second housing 28 until the actuator 56 resides in the second groove portion 74 and abuts the second leg 62. This causes the outer rod tube 20 to move towards the second housing 28 causing the inner rod 22 to push the hook 44 out of the second housing 28 and open, see FIGS. 1 and 3. Once the hook 44 has engaged the cable, the user pulls back on the hook operating assembly 50 moving the first housing 24 towards the first end 26 of the shotgun stick 10 to a second operating position, see FIG. 4. In the second operating position, the actuator 56 resides in the first groove portion 72 and abuts against the wall 76. Further, movement of the first housing 24 causes the outer rod tube 20 to move towards the first end 26 causing the inner rod 22 to pull the hook 44 into the second housing 28 such that the cable is captured by the hook 44.

Once the cable “C” has been captured by the hook 44, the user may then move the hook operating assembly 50 to a third operating position where the cable is compressed between the hook 44 and the second housing 28. The pawl 54 engages the gear track 52 to maintain the hook operating assembly 50 in the second and third positions and anywhere in between. To release the cable, the user presses the pawl 54 to disengage the gear track 52, allowing the hook operating assembly 50 to move to the second position. The user then presses the pawl 54 and actuator 56 to allow the actuator 56 to clear the wall 76 and move into the second groove portion 74. The hook operating assembly 50 is moved to the first position, thereby opening the hook 44 and releasing the cable.

Referring to FIGS. 8-19, as discussed above, the shotgun stick 10 is configured to extend and retract between first, second, and third lengths “L”. The hotstick assembly 12 is extended or retracted using actuator 32 which engages aperture 34 when the inner tube 16 is moved along the outer tube 14. Further, the telescoping rod assembly 18 is configured to extend and retract with the hotstick assembly 12. The inner rod 22 is configured to slide within the outer rod tube 20 and locked in position by locking mechanism 46 which is connected to the second end 48 of the outer rod tube 20.

As illustrated, the locking mechanism 46 includes a housing 100 having a bore 102 therethrough. A first end 104 of the housing is secured to the outer rod tube 20. A pair of opposed spring biased actuators 106 and 108 extend into the housing 100 and are positioned adjacent the bore 102 and the second end 48 of the outer rod tube 20. The actuators 106 and 108 are biased in a locked position, FIG. 10, by springs 110. As shown in FIG. 9, when in the locked position, a portion of the actuators 106 and 108 extends into the bore 102 to prevent the inner rod 22 from extending or retracting (discussed in more detail below). By actuating the actuators 106 and 108 (pressing the actuators inwardly into the housing), the springs 110 are compressed and the actuators 106 and 108 are moved clear of the bore, FIGS. 11 and 12, to allow the inner rod 22 to extend or retract.

As illustrated, actuator 106 is positioned on a first side 100A of the housing 100 and actuator 108 is positioned on a second side 100B of the housing 100 to allow the actuators 106 and 108 to be pressed inwardly into the housing 100 and clear the bore at the same time. As shown in FIG. 13, each of the actuators 106 and 108 include a body 116 having a first actuating end 118, a second engagement end 120, and an aperture 122 extending through the body 116 at a location between the first actuating end 118 and second engagement end 120 to permit the inner rod 22 to slide through the aperture 116. As illustrated in FIG. 9, the first actuating end 118 extends out of the housing 100 when in the locked position to allow a user to actuate the actuators 106 and 108. The second engagement end 120 includes a slot engagement member 124 that at least partially interferes with the aperture 122. As shown in FIG. 10, when in the locked position, the inner rod 22 extends through the aperture 122 and the slot engagement member 124 engages a slot of the inner rod 22 to prevent the inner rod 22 from moving inwardly or outwardly from the outer rod tube 20 (discussed in more detail below). When actuated, the slot engagement member 124 disengages the slot to permit the inner rod 22 to move.

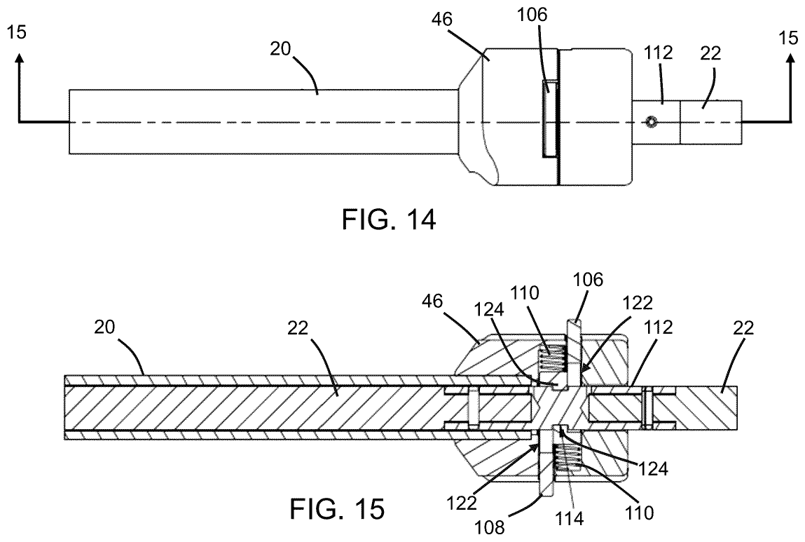

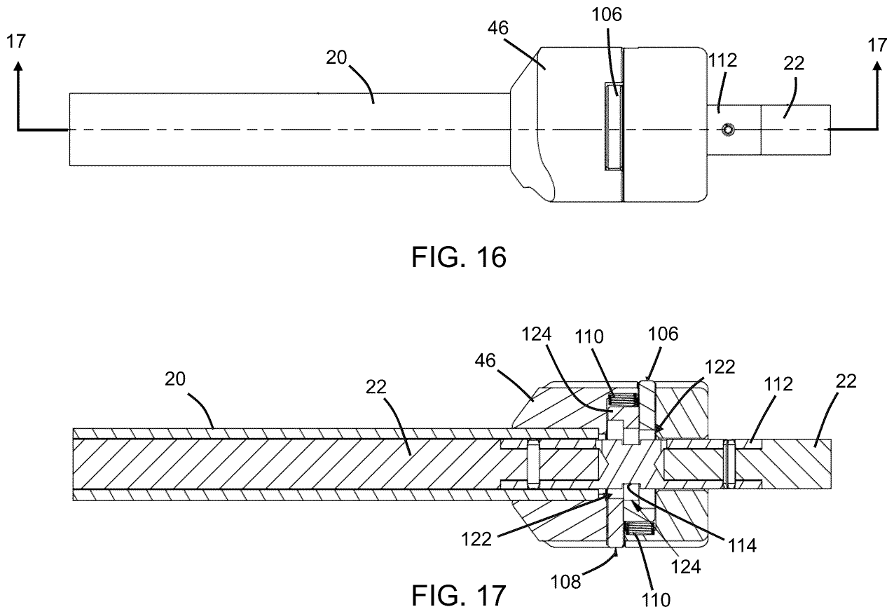

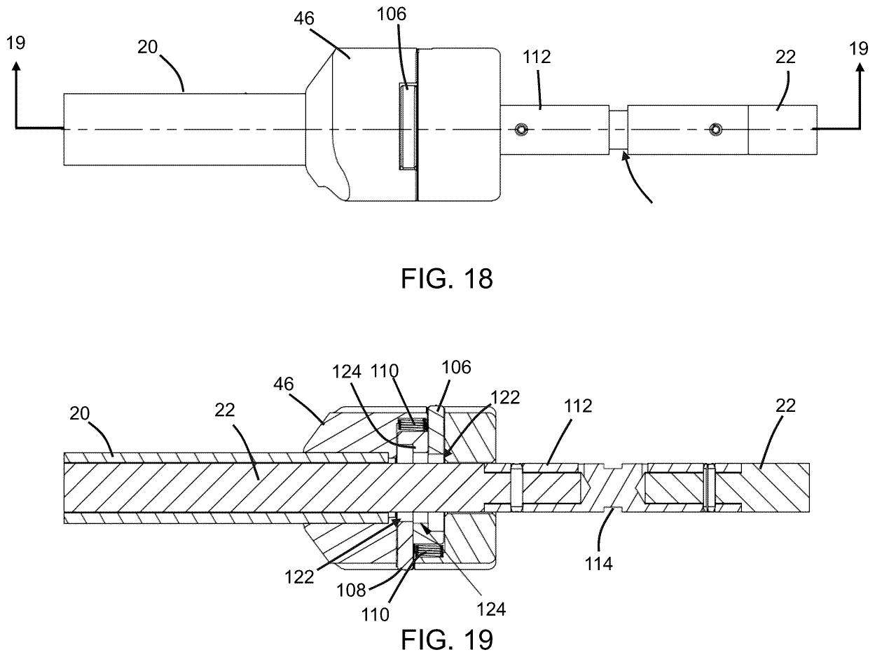

As shown in FIGS. 14 and 15, the inner rod 22 includes one or more rod sections 22A, 22B connected together by a rod connector 112 pinned to ends of the rod sections 22A, 22B. The rod connector 112 includes a slot 114 for being engaged by the slot engagement member 124 of the actuators 106 and 108. As the inner rod 22 is moved inwardly or outwardly from the outer rod tube 20, the inner rod 22 moves through the bore 102 and aperture 122 until the slot engagement members 124 of the actuators 106 and 108 engage the slot 114 of the rod connector 112. To move the inner rod 22 inwardly or outwardly from the outer rod tube 20, the user presses the actuators 106 and 108 to disengage the slot engagement members of the actuators 106 and 108 from the slot 114, FIGS. 16 and 17, and then moves the inner rod 22, FIGS. 18 and 19, until the slot engagement members 124 of the actuators 106 and 108 engage a slot 114 of another rod connector 112 or the shotgun stick 10 is either fully extended or fully retracted.

In operation, a user extends or retracts the shotgun stick 10 between the first, second, and third lengths by first actuating actuator 32 to disengage actuator 32 from aperture 34. This disengages the inner tube 16 of the hotstick assembly 12 from the outer tube 14 to allow the inner tube 16 to be moved inwardly or outwardly with respect to the outer tube 14. Once the inner tube 16 is free to move, the user actuates both actuators 106 and 108 to disengage the actuators 106 and 108 from the slot 114 of the rod connector 112 to allow the inner rod 22 to move inwardly or outwardly with respect to outer rod tube 20. To release the inner rod 22, both actuators 106 and 108 must be actuated. Actuating only one of the actuators 106 and 108 does not release the inner rod 22 for movement. This prevents an accidental disengagement by hitting one of the actuators against a structure when in use. With the inner tube 16 and inner rod 22 released, the shotgun stick 10 may be extended or retracted to a desired length. It should be appreciated that while the locking mechanism is being described with respect to a shotgun stick and rod assembly, the locking mechanism may be used with other suitable applications and is not limited to use with a shotgun stick or rod assembly.

The foregoing has described a telescoping shotgun stick. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

What is claimed is:

1. A telescoping shotgun stick, comprising:
a hotstick assembly including an outer tube and an inner tube configured to slide within the outer tube;
a telescoping rod assembly including:
an outer rod tube;
an inner rod configured to slide within the outer rod tube; and
a locking mechanism secured to a second end of the outer rod tube, the locking mechanism having a housing with a bore therethrough and first and second actuators extending into the bore, wherein when in an unactuated position, the first and second actuators prevent the inner rod from sliding in the outer tube and when in an actuated position, the first and second actuators allow the inner rod to slide in the outer tube;
a hook connected to an end of the inner rod; and
a hook operating assembly connected to a first end of the outer rod tube, wherein movement of the hook operating assembly causes the hook to move from an open position to a closed position.

2. The stick of claim 1, wherein the first actuator is positioned on a first side of the housing and the second actuator is positioned on an opposing second side of the housing.

3. The stick of claim 1, wherein each of the first and second actuators include a body having a first actuating end, a second engagement end spaced from the first actuating end, and an aperture extending through the body between the first actuating end and second engagement end to permit the inner rod to slide through the aperture.

4. The stick of claim 3, wherein the second engagement end includes a slot engagement member for engaging a slot of the inner rod, the slot engagement member at least partially interfering with the aperture.

5. The stick of claim 1, wherein the inner rod includes first and second rod sections connected together by a rod connector in an end to end configuration.

6. The stick of claim 5, wherein the rod connector includes a slot for engagement by the first and second actuators to prevent the inner rod from sliding in the outer rod tube.

7. The stick of claim 1, wherein the inner tube is locked in position relative to the outer tube by an actuator extending through an aperture in the outer tube.

8. The stick of claim 1, wherein the hook operating assembly includes a housing, a gear rack connected to the outer tube, and a pawl pivotally connected to the housing for engagement with the gear rack.

9. The stick of claim 8, wherein the housing is connected to the first end of the outer rod tube.

10. The stick of claim 8, wherein the hook operating assembly further includes an actuator disposed in the housing adapted to permit the hook operating assembly to move to a first operating position where the hook is fully opened.

11. A locking mechanism, comprising:
a housing having a bore therethrough;
a first actuator disposed on a first side of the housing and a second actuator disposed on a second side of the housing, wherein each of the first and second actuators include an aperture extending therethrough;
wherein in an unactuated position, at least a portion of each of the first and second actuators interfere with the bore, and in an actuated position, the first and second actuators do not interfere with the bore.

12. The locking mechanism of claim 11, further including a first spring adapted to bias the first actuator in the unactuated position and a second spring adapted to bias the second actuator in the unactuated position.

13. The locking mechanism of claim 11, wherein each of the first and second actuators include:
a body;
a first actuating end extending out of the housing for actuation by a user;
a second engagement end spaced from the first actuating end; and
an aperture extending through the body between the first actuating end and the second engagement end.

14. The locking mechanism of claim 13, wherein in the actuated position, the aperture of the first and second actuators is aligned with the bore of the housing, and wherein in the unactuated position, the aperture of the first and second actuators is not aligned with the bore.

15. A locking mechanism for a telescoping rod assembly having an outer rod tube and an inner rod, comprising:
a housing having a bore therethrough, the housing being connected to an end of the outer rod tube;
a first actuator disposed on a first side of the housing and a second actuator disposed on a second side of the housing, wherein each of the first and second actuators include an aperture extending therethrough for receiving the inner rod therein;
wherein in an unactuated position, at least a portion of each of the first and second actuators interfere with the bore to prevent the inner rod from sliding through the bore, and in an actuated position, the first and second actuators do not interfere with the bore, thereby allowing the inner rod to slide through the bore.

16. The locking mechanism of claim 15, further including a first spring adapted to bias the first actuator in the unactuated position to prevent the inner rod from sliding and a second spring adapted to bias the second actuator in the unactuated position to prevent the inner rod from sliding.

17. The locking mechanism of claim 15, wherein each of the first and second actuators include:
a body;
a first actuating end extending out of the housing for actuation by a user;
a second engagement end spaced from the first actuating end for engagement with the inner rod; and
an aperture extending through the body between the first actuating end and the second engagement end to permit the inner rod to slide through the aperture.

18. The locking mechanism of claim 17, wherein the second engagement end includes a slot engagement member for engaging a slot of the inner rod, the slot engagement member at least partially interfering with the aperture.

19. The locking mechanism of claim 17, wherein in the actuated position, the aperture of the first and second actuators is aligned with the bore of the housing to permit the inner rod to slide through both the aperture and the bore, and wherein in the unactuated position, the aperture of the first and second actuators is not aligned with the bore such that the second engagement end of the first and second actuators interfere with the bore and prevent the inner rod from sliding in the aperture and the bore.

20. A method of operating the telescoping shotgun stick of claim 1, comprising:
moving the hook operating assembly to a first position to open the hook;
receiving a cable in the hook and moving the hook operating assembly to a second position where the hook is closed to capture the cable; and
moving the hook operating assembly to a third position where the cable is compressed between the hook and a housing connected to a second end of the hotstick assembly.

21. The method of claim 20, further including the steps of:
disengaging the inner tube of the hotstick assembly from the outer tube;
actuating the first and second actuators of the locking mechanism to disengage the locking mechanism from the inner rod; and
extending or retracting the telescoping shotgun stick to a desired length.

22. The method of claim 20, wherein the step of moving the hook operating assembly to the first position includes the steps of actuating an actuator and pawl of the of the hook operating assembly at the same time and pushing the hook operating assembly forward towards the second end of the hotstick assembly.

23. The method of claim 20, wherein the step of moving the hook operating assembly to the second position includes the step of pulling the hook operating assembly from the first position towards a first end of the hotstick assembly into the second position.

24. The method of claim 20, wherein the step of moving the hook operating assembly to the third position includes the step of pulling the hook operating assembly from the second position towards a first end of the hotstick assembly into the third position.
